(19) United States
(12) Patent Application Publication
(10) Pub. No.: US 2013/0166275 A1
(43) Pub. Date: Jun. 27, 2013

(54) SYSTEM AND METHOD FOR TRANSLATING USER MESSAGE

(71) Applicants: Heechan YANG, Seongnam-si (KR); Hyuk JUNG, Seongnam-si (KR); Dongri JIN, Seongnam-si (KR)

(72) Inventors: Heechan YANG, Seongnam-si (KR); Hyuk JUNG, Seongnam-si (KR); Dongri JIN, Seongnam-si (KR)

(73) Assignee: NHN CORPORATION, Seongnam-si (KR)

(21) Appl. No.: 13/550,467

(22) Filed: Jul. 16, 2012

(30) Foreign Application Priority Data
Dec. 21, 2011 (KR) 10-2011-0139466

(51) Int. Cl. G06F 17/28

(52) U.S. Cl. 704/2

(57) ABSTRACT

A method for providing an interpretation service using a messaging application includes receiving a message of a first language in a conversation session provided by the messaging application in a terminal; translating the message of the first language into a message of a second language; and providing the message of the second language in the conversation session. A system to provide a messaging service through a messaging application includes an access manager to manage access of a terminal over a network, and to receive a message of a first language through a conversation session provided by the messaging application; and a processor to translate the message of the first language into a message of a second language, in which the access manager transmits the message of the second language to the terminal over the network to display the message of the second language in the conversation session.

### CROSS-REFERENCE TO RELATED APPLICATION

This application claims priority from and the benefit of Korean Patent Application No. 10-2011-0139466, filed on Dec. 21, 2011, which is hereby incorporated by reference for all purposes as if fully set forth herein.

### BACKGROUND

1. Field

The following description relates to a system and method for providing a translation service of a message inputted, transmitted, or received.

2. Discussion of the Background

With distribution of information technology (IT) capable terminals with a touch sense display, for example, a smart phone, a tablet personal computer (PC), and the like, various instant messaging service applications may be supported in a terminal.

A messaging service using an instant messaging application may provide various services in addition to a messaging service, with or without additional charge in a network accessible environment. In part, because of additional services provided by the messaging service using the instant messaging application, many users may be increasing in their interest in using the messaging service over an existing short message service (SMS) or multimedia messaging service (MMS).

Accordingly, many instant messaging applications are provided and some of the instant messaging applications have been already serviced in a plurality of countries to support various languages.

In an instant messaging service, a user may add a conversation friend using contact information stored in a terminal of a user (a user terminal) or through a user selection. The user may open conversation sessions with added friends to transmit and receive messages from the user's added friends.

However, if conversation is conducted between user terminals using different languages, the messaging service may have difficulty facilitating a conversation due to the language difference.

The above information disclosed in this Background section is only for enhancement of understanding of the background of the invention and therefore it may contain information that does not form any part of the prior art nor what the prior art may suggest to a person of ordinary skill in the art.

### SUMMARY

Exemplary embodiments of the present invention provide a messaging service providing system and method for providing a virtual user software bot to participate in a conversation session in a messaging application to provide a translation service of messages in different languages in real time.

Additional features of the invention will be set forth in the description which follows, and in part will be apparent from the description, or may be learned by practice of the invention.

Exemplary embodiments of the present invention provide a method for providing an interpretation service using a messaging application including receiving a message of a first language in a conversation session provided by the messaging application in a terminal; translating the message of the first language into a message of a second language; and providing the message of the second language in the conversation session.

Exemplary embodiments of the present invention provide a method for providing an interpretation service through a messaging application including executing a conversation session in the messaging application of a terminal; receiving a message of a first language in the conversation session; translating the message of the first language into a message of a second language using a software bot; and providing the message of the second language in the conversation session.

Exemplary embodiments of the present invention provide a system to provide a messaging service through a messaging application including an access manager to manage access of a terminal over a network, and to receive a message of a first language through a conversation session provided by the messaging application; and a processor to translate the message of the first language into a message of a second language, in which the access manager transmits the message of the second language to the terminal over the network to display the message of the second language in the conversation session.

Exemplary embodiments of the present invention provide a non-transitory computer-readable medium comprising a program to perform a method for providing a translation operation in an instant messaging application, the method including receiving a message of a first language in a conversation session provided by the instant messaging application of a terminal; translating the message of the first language into a message of the second language; and providing the message of the second language in the conversation session.

Exemplary embodiments of the present invention provide a non-transitory computer-readable medium comprising a program to perform a method for providing a translation operation in an instant messaging application, the method including executing a conversation session in the messaging application of a terminal; receiving a message of a first language in the conversation session; translating the message of the first language into a message of a second language using a software bot; and providing the message of the second language in the conversation session.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a connection configuration between a messaging service providing system and user terminals according to an exemplary embodiment of the present invention.

FIG. 2 is a block diagram illustrating a messaging service providing system according to an exemplary embodiment of the present invention.

FIG. 3 is a diagram illustrating user interface display icons of an instant messaging application according to an exemplary embodiment of the present invention.

FIG. 4 is a diagram illustrating a user interface to provide a friend adding operation in an instant messaging application according to an exemplary embodiment of the present invention.

FIG. 5 is a diagram illustrating user interface display software bots to provide a translation operation according to an exemplary embodiment of the present invention.

FIG. 6 and FIG. 7 are diagrams illustrating an interpretation process by a software bot of a conversation between users in an instant messaging application according to an exemplary embodiment of the present invention.

FIG. 8 is a flowchart illustrating a messaging service providing method according to an exemplary embodiment of the present invention.

FIG. 9 is a diagram illustrating user interface displaying software bots capable of being added in an instant messaging service according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

It will be understood that if an element is referred to as being “connected to” another element, it can be directly connected to the other element, or intervening elements may be present.

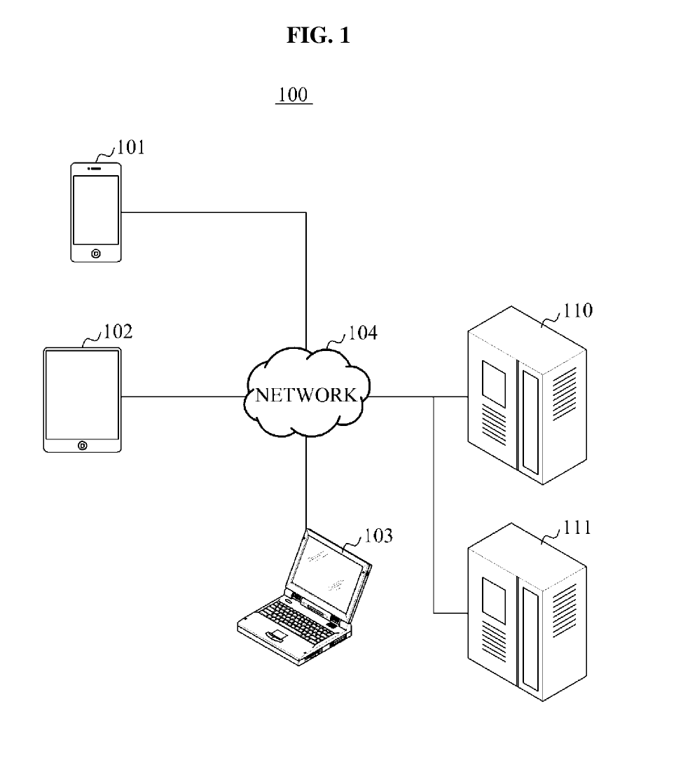

FIG. 1 is a diagram 100 illustrating a connection configuration between a messaging service providing system 110 and a user terminal 101, a user terminal 102, and a user terminal 103 according to an exemplary embodiment of the present invention. In contrast, when an element is referred to as being “directly connected to” another element, there are no intervening elements present.

Referring to FIG. 1, a messaging service providing system 110 may provide an instant messaging service over a network 104. The instant messaging service may be provided from the messaging service providing system 110 through instant messaging applications installed in the user terminal 101, user terminal 102, and user terminal 103. In an example, the user terminal may include a smart phone, a smart television, a tablet computer, a stationary computer (e.g., desktop), and the like.

While users of the user terminal 101, user terminal 102, and user terminal 103 are making conversation in an instant messaging session, the messaging service providing system 110 may provide a translation service or an interpretation service (hereinafter referred to as “translation”) to translate a user inputted message from a first language to a second language and vice versa.

For example, messages inputted and transmitted through the instant messaging application may include a text message, a voice message, and the like. The translation service may be selectively provided based on a type of a message.

In an example, the translation service may be provided using a software bot. A software bot that participates in an instant messaging session between users may operate as a virtual user to translate messages being transmitted and received by a user. Such software bot may be referred to as an interpretation bot.

The messaging service providing system 110 may include a database to support a translation service. More specifically, the database may store various characters and terms of a first language and a second language. Further, the database may also store various sentence structure rules associated with the respective language so that conversations provided in different languages may be translated coherently. The messaging service providing system 110 may further interact with a separate external server 111 to translate a message. For example, the external server 111 may be a translation engine, which may process the messages received in a first language and translate the received message to a second language by communicating with the messaging service providing system 110.

A configuration of the messaging service providing system 110 including a translation database to provide a translation service may be supplemented through interaction with the external server 111. However, a translation engine may also be included in the messaging service providing system 110.

Hereinafter, a process of providing a translation service by an interpretation bot in an instant messaging application according to an exemplary embodiment of the present invention will be described.

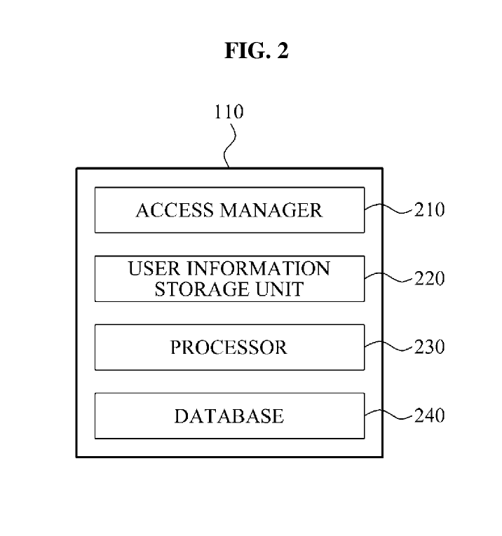

FIG. 2 is a block diagram illustrating the messaging service providing system 110 of FIG. 1 according to an exemplary embodiment of the present invention.

An access manager 210 may be a physical or logical communication module configured to connect the messaging service providing system 110 and various user terminals, including the user terminal 101, user terminal 102, and user terminal 103, over the network 104.

Messages received from the user terminals may be transferred to a processor 230 via the access manager 210. If translation operation is completed with respect to at least one of the transmitted messages, the result may be transferred to at least one of the user terminal 101, user terminal 102, and user terminal 103 via the access manager 210. In an example, the result or the translated message may be transmitted to a target terminal, at least one of the user terminal 101, user terminal 102, and user terminal 103, through a push notice or push alarm. The push notice or the push alarm may be transmitted to the target terminal to notify the user of the target terminal of the translated message.

A user information storage unit 220 may refer to a type of physical or logical configuration that may store and manage various information, including user subscription information, software bot information, conversation session information, and the like.

While receiving and transferring a message from and to another user in a conversation session, the processor 230 may translate the transferred message to provide a translation service using an interpretation bot. The translation service provided by the interpretation bot may be provided in real-time.

In each of messaging applications executed in the user terminals, a message transmitted and received from a user terminal to the messaging service providing system 110 may be translated by the interpretation bot in a real-time conversation form. In correspondence to an expression that the user makes “conversation” through the instant messaging service, translation of a message may also be expressed as interpretation of a user conversation.

The translation service described above may be performed, for example, between English and Japanese, which will be further described below.

A database 240 may store information that is used by the processor 230 if an interpretation software bot interprets conversation between users. For example, matching relationship between an English word and a Japanese word may be stored in a data structure. In addition, information related to a sentence structure of the English language and the Japanese language may be stored (e.g., English language may follow subject—>verb order, whereas the Japanese language may follow verb—>subject order) so that messages provided in different languages may be translated coherently.

Further, the database 240 may operate as data storage and the processor 230 may perform translation operation. If the database 240 is configured as the external server 111 of FIG. 1, the database 240 may perform at least a portion of translation operation of the processor 230 in addition to the data storage. Hereinafter, even though not particularly described, the configuration of FIG. 2 may be understood to include both a case where the translation engine is provided outside the messaging service providing system 110 and a case where the translation engine is provided within the messaging service providing system 110.

Hereinafter, various operations or applications performed by the messaging service providing system 110 will be described. Here, even though configurations of the access manager 210, the user information storage unit 220, the processor 230, and the database 240 may not be particularly specified, content may be understood to those skilled in the art. Further, the described configurations may be understood as exemplary embodiments and the scope of the invention is not limited thereto or restricted by a predetermined configuration or physical/logical structure.

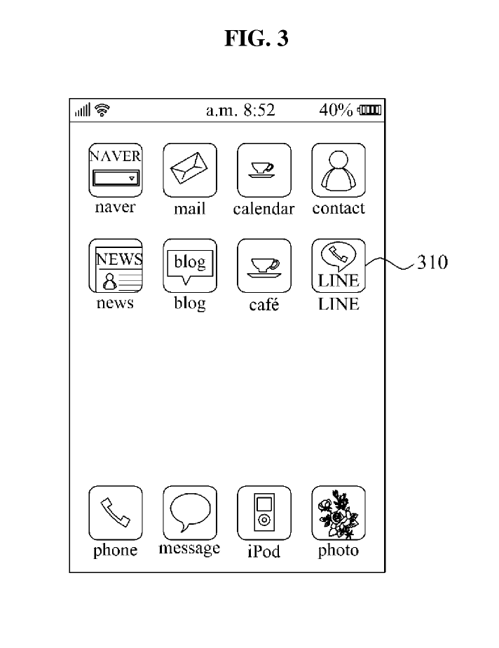

FIG. 3 is a diagram illustrating user interface display icons of an instant messaging application according to an exemplary embodiment of the present invention.

The instant messaging application 310 may be distributed in an application store or market as one of many applications that may be installed in a user terminal.

If a user executes the instant messaging application 310, the user may open a conversation session with registered friends to transmit and/or receive messages to and from the friends. An interpretation bot, which may be a virtual artificial software program, may be added as a friend. The added interpretation bot may translate messages transmitted and/or received within the conversation session.

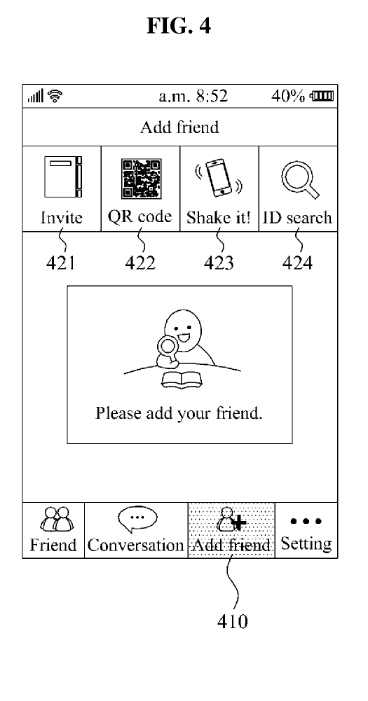

Hereinafter, a process of adding a friend and providing a translation service of a message after executing the instant messaging application will be described with reference to FIG. 4.

FIG. 4 is a diagram illustrating a user interface to provide a friend adding operation in an instant messaging application according to an exemplary embodiment of the present invention.

The instant messaging application may automatically access a contact list of a user terminal to add, to a friend list, friends having installed the same or similar applications. Further, the instant messaging application may also directly add a friend using the user interface of FIG. 4.

For example, “invite” icon 421 may access a contact stored within a user terminal to recommend a friend who may not use an instant messaging application used by a user to install the respective instant messaging application.

“Quick response (QR) code” icon 422 may read a QR code and add, as a friend, another user or a virtual software bot corresponding to the QR code.

“Shake it” icon 423 may enable neighboring user terminals to add each other as a friend based on their position information. “Shake it” icon 423 may also enable the user terminals to add other neighboring user terminals using near field radio communication recognition.

“ID search” icon 424 may enable a friend to be manually added by directly searching for identification (ID) of another user.

In addition, operations of “add friend” icon 410 may perform to add various software bots in addition to or in lieu of an actual user. More specifically, a software bot may be added as a friend by the messaging service providing system 110.

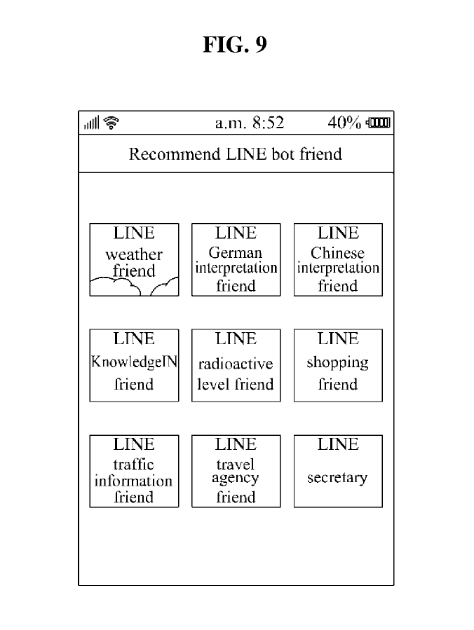

As described above, various software bots may be provided through a friend recommendation operation of the messaging service providing system 110, and may also be provided from a separately provided software bot store. Various types of software bots that may be added will be further described with reference to FIG. 9.

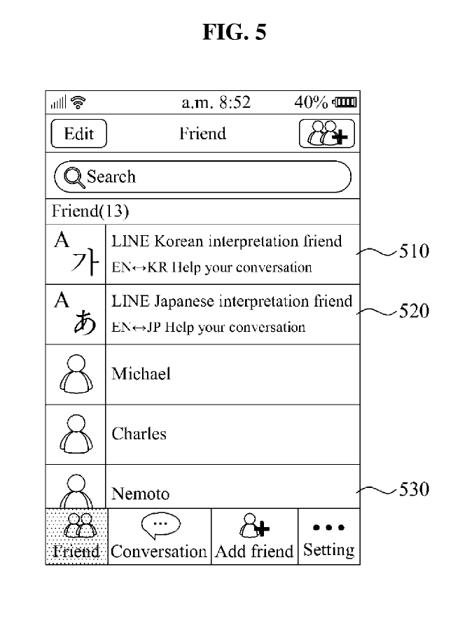

FIG. 5 is a diagram illustrating user interface display software bots to provide a translation operation according to an exemplary embodiment of the present invention.

Referring to FIG. 5, “LINE Korean interpretation friend” 510, which may be a software bot that provides an interpretation service between Korean and English, and “LINE Japanese interpretation friend” 520, which may be a software bot that provides an interpretation service between English and Japanese, may be included in a friend list.

A user may add the above software bots as friends along with or in lieu of actual users, or may delete the software bots from the friend list. In addition, the user may open a conversation session between users so that the software bots may participate in conversation during a conversation or chat session between users. More specifically, the software bot may participate as a third user in the conversation session, interpreting messages provided by the users. In addition, the software bot providing interpretation service may participate in a conversation between a user and another service providing software bot (e.g., weather information bot).

Accordingly, since the user may allow virtual users to participate in a conversation session, it may be possible to provide a user experience (UX) differentiated from conventional instant messaging services.

“LINE Korean interpretation friend” 510 and “LINE Japanese interpretation friend” 520 are provided as examples and no limitations were intended by using the respective icons. Accordingly, other software bots used for providing interpretation operation between different languages may be extended.

In addition to software bots that performs the translation/interpretation operation, software bots that provide various information may also be provided and added as a friend. For example, other service software bots may include a software bot “LINE weather friend”, which may provide weather information in a form of conversation with a user. Further, if the service providing software bot “LINE weather friend” is provided in a language different from a user, interpretation software bot may participate in the chat session between the “LINE weather friend” software bot and the user to provide a translation service operation.

Hereinafter, an example in which a user receives an interpretation service by allowing “LINE Japanese interpretation friend” 520 to participate in conversation while having a conversation with a Japanese friend “Nemoto” 530 will be described.

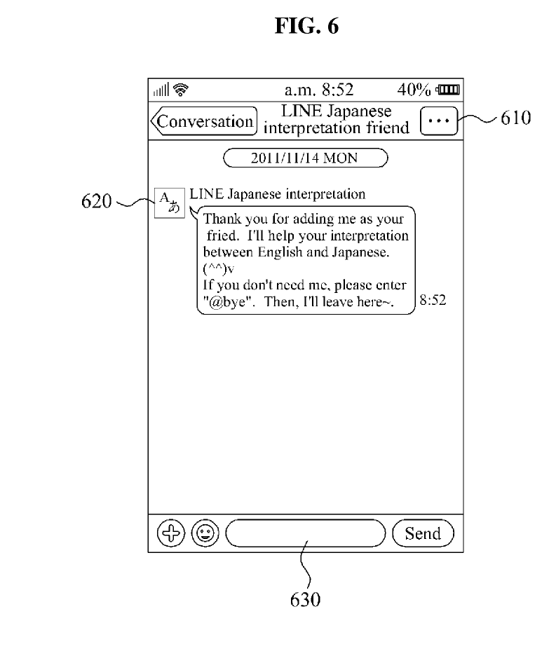

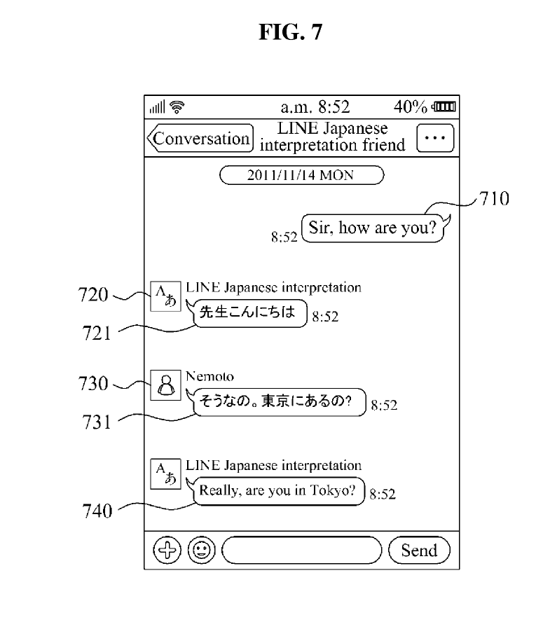

FIG. 6 and FIG. 7 are diagrams illustrating an interpretation process, by a software bot of a conversation between users in an instant messaging application according to an exemplary embodiment of the present invention.

FIG. 6 illustrates an example in which a conversation session is opened. In this example, a user has opened a conversation session with “LINE Japanese interpretation friend” 620. The user may add the actual user “Nemoto” 530 in an interface 610 as an added friend.

An order or command of allowing a virtual software bot and an actual user to participate in a conversation session may be arbitrarily determined. The method may be similar to a method for performing a multilateral conversation in a general instant messaging service.

If “LINE Japanese interpretation friend” 620 participates in the conversation session, “LINE Japanese interpretation friend” 620 may provide a usage tip together with simple greeting as shown in FIG. 6.

If “LINE Japanese interpretation friend” 620 participates in the conversation, characters in a first language inputted via a message input interface may be translated to characters in a second language in real time. Further, the “LINE Japanese interpretation friend” 620 may also apply sentence structure rules so that the provided translation may be understood by the users.

Although not illustrated, a voice message of the user may also be interpreted using similar software bots to provide an extended capability.

As shown in FIG. 7, if a user of a terminal transmits a message 710, “Sir, how are you?” in English, the message 710 may be initially transmitted to a user identified as Nemoto 730 in English. Then, a message 721 translated into Japanese by “LINE Japanese interpretation friend” 720 may be directly transmitted to “Nemoto” 730 and the terminal user.

If “Nemoto” 730 transmits a message 731 in Japanese, the message 731 may be transmitted to the user terminal in Japanese. Then, a message 740 translated into English, “Really, are you in Tokyo?”, by “LINE Japanese interpretation friend” 720 may be transmitted to the terminal user and “Nemoto” 730.

Although the interpretation bot is described as a third participant in a conversation session, it is not limited thereto. The interpretation bot may also be operating in a background and may translate the received message in a foreign language into a language understood by a user. Accordingly, users may communicate with one another without being aware that they may be sending messages in different languages.

Through the above process, real-time messaging may be enabled between users using different languages. Therefore, real-time conversation sessions may be enabled between users from different countries. In addition, companies may be able to directly promote their products and provide a customer service to customers living in different countries. Social networks or an idea exchange forum (e.g., KnowledgeIN) service may be expanded to users using various languages beyond the border.

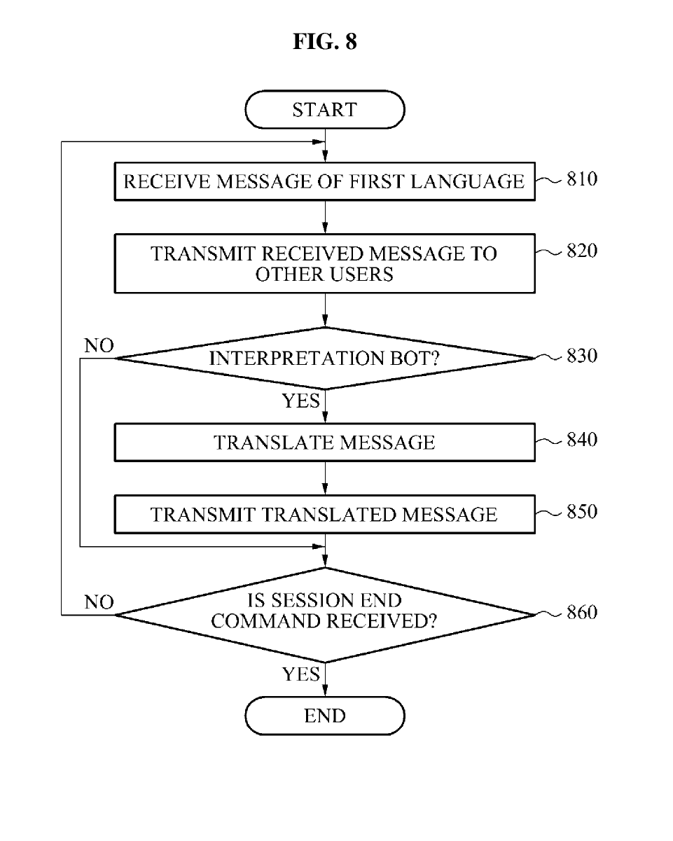

FIG. 8 is a flowchart illustrating a messaging service providing method according to an exemplary embodiment of the present invention. The method of FIG. 8 below will be described as if performed by the messaging service providing system of FIG. 1, but is not limited as such.

In operation 810, the access manager 210 of the messaging service providing system 110 may receive a message inputted by a user in a first language in a conversation session, and may transfer the received message to the processor 230.

In operation 820, the message of the first language may be transmitted to other users participating in the conversation session.

In operation 830, a determination of whether an interpretation software bot, for example, LINE interpretation bot, is participating in the conversation session is made. If it is determined that the interpretation software bot is not participating in the conversation session, the process may proceed to operation 860. Alternatively, although not illustrated, if it is determined that the interpretation software bot is not participating in the conversation session, the processor 230 may request the interpretation software bot to participate in the conversation session.

In operation 840, if it is determined that the interpretation software bot is participating in the conversation session, the processor 230 may translate the message of the first language into a second language by referring to the database 240.

In operation 850, the processor 230 may transmit the translated message to the users participating in the conversation session via the access manager 210.

The above process may be repeated until a session end command is received in operation 860.

FIG. 9 is a diagram illustrating user interface displaying software bots that may be added in an instant messaging service according to an exemplary embodiment of the present invention.

Recommendation of the software bots may be understood as a friend recommend list. In addition, the recommendation of the software bots may also be understood as a software bot store in which paid or free transaction is available.

The software bots or interpretation bots that may be provided may include, without limitation, “Japanese interpretation friend”, “Korean interpretation friend”, “German interpretation friend”, “Chinese interpretation friend”, and the like.

In addition, other software bots that provide a variety of other services may be included in the recommendation list. For example, a “weather friend” that may provide weather information requested by a user using a weather information database, a “KnowledgeIN friend” that may provide a response to query information requested by a user in interaction with a KnowledgeIN service, a “radioactive level friend” that may provide a response to a query of a user asking a radioactive level of a predetermined area, a “shopping friend” that may provide price or product information of a shopping article in response to a user query, a “traffic information friend” that may provide information while conversing with a user about traffic information, a “travel agency friend” that may provide information about a flight or accommodation and make a reservation as a proxy, a “secretary” that may schedule an itinerary or a meeting for the user, and the like.

Even though not illustrated, a single software bot may perform a plurality of operations, and the operations may be extended without departing from the spirit of the present invention. For example, a single interpretation bot may simultaneously interpret a plurality of languages.

The various software bots may be uploaded and distributed by various developers or providers in addition to an operation entity of the messaging service providing system 110. Companies may provide software bots free of charge or on paid basis according to their business purpose.

Exemplary embodiments of the invention may provide a messaging service that may be distinguished with respect to UX from conventional instant messaging services. Virtual software bots may be allowed to participate in conversation as if the software bots are actual users, and the software bots may provide information within a conversation session based on their own role.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both a machine code, such as produced by a compiler, and files containing higher level code that may be executed by the computer using an interpreter. The described hardware devices may be configured to act as one or more software modules in order to perform the operations of the above-described embodiments of the present invention.

According to exemplary embodiments of the present invention, users using different languages may transmit and/or receive messages in real time in their native languages through a messaging application. Therefore, it may be possible to enhance user convenience.

According to exemplary embodiments of the present invention, a messaging application provider may build social networks among users using various languages and thus, may also expand business and create a revenue model.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for providing an interpretation service using a messaging application, the method comprising:
receiving a message of a first language in a conversation session provided by the messaging application in a terminal;
translating the message of the first language into a message of a second language; and
providing the message of the second language in the conversation session.

2. The method of claim 1, wherein providing the message of the second language comprises transmitting the message of the second language to a target terminal over a network and displaying the message of the second language in the conversation session.

3. The method of claim 1, further comprising:
registering a software bot in the messaging application,
wherein the software bot translates the message of the first language into the message of the second language.

4. The method of claim 3, wherein the software bot participates in the conversation session as a participant, and
the software bot provides the translation operation during the conversation session.

5. The method of claim 1, wherein the providing the message of the second language comprises transmitting the message of the second language to a target terminal participating in the conversation session.

6. The method of claim 5, wherein the message of the second language transmitted to the target terminal is provided to the target terminal through a push notice.

7. The method of claim 1, wherein the messaging service is an instant messaging service.

8. The method of claim 1, wherein translating the message of the first language comprises translating the message of the first language into the message of the second language in real-time.

9. A method for providing an interpretation service through a messaging application, the method comprising:
executing a conversation session in the messaging application of a terminal;
receiving a message of a first language in the conversation session;
translating the message of the first language into a message of a second language using a software bot; and
providing the message of the second language in the conversation session.

10. The method of claim 9, further comprising:
recommending the software bot to be registered as a participant in the messaging application, wherein the software bot translates the message of the first language into the message of the second language during the conversation session as a participant.

11. A system to provide a messaging service through a messaging application, the system comprising:
an access manager to manage access of a terminal over a network, and to receive a message of a first language through a conversation session provided by the messaging application; and
a processor to translate the message of the first language into a message of a second language,
wherein the access manager transmits the message of the second language to the terminal over the network to display the message of the second language in the conversation session.

12. The system of claim 11, wherein a software bot translates the message of the first language into the message of the second language during the conversation session as a participant in the conversation session.

13. The system of claim 12, wherein in response to a request, the software bot is registered as a participant in the messaging application.

14. The system of claim 11, wherein if the message of the first language is transmitted to a target terminal participating in the conversation session, the access manager transmits the message of the second language to the target terminal.

15. The system of claim 14, wherein the message of the second language transmitted to the target terminal is provided to the target terminal using a push notice.

16. The system of claim 11, further comprising:
a database to store at least one of characters, terms, and sentence structure rules of the first language and the second language.

17. The system of claim 11, wherein the messaging service is an instant messaging service.

18. The system of claim 11, wherein the message of the first language is translated into the message of the second language in real-time.

19. A non-transitory computer-readable medium comprising a program to perform a method for providing a translation operation in an instant messaging application, the method comprising:
receiving a message of a first language in a conversation session provided by the instant messaging application of a terminal;
translating the message of the first language into a message of the second language; and
providing the message of the second language in the conversation session.

20. A non-transitory computer-readable medium comprising a program to perform a method for providing a translation operation in an instant messaging application, the method comprising:
executing a conversation session in the messaging application of a terminal;
receiving a message of a first language in the conversation session;
translating the message of the first language into a message of a second language using a software bot; and
providing the message of the second language in the conversation session.
